(19) United States
(12) Patent Application Publication
(10) Pub. No.: US 2024/0208273 A1
(43) Pub. Date: Jun. 27, 2024

(54) PNEUMATIC TIRE

(71) Applicant: Sumitomo Rubber Industries, Ltd., Kobe-shi (JP)

(72) Inventors: Satoko TSUJIBAYASHI, Kobe-shi (JP); Tetsuya KITANO, Kobe-shi (JP)

(73) Assignee: Sumitomo Rubber Industries, Ltd., Kobe-shi (JP)

(21) Appl. No.: 18/393,700

(22) Filed: Dec. 22, 2023

(30) Foreign Application Priority Data
Dec. 22, 2022 (JP) 2022-205897

(51) Int. Cl. B60C 15/024

(52) U.S. Cl. CPC B60C 15/0242

(57) ABSTRACT

A pneumatic tire can include a plurality of recesses arranged in a tire circumferential direction. Each recess can include a sidewall surface extending inward in a tire axial direction from an outer surface of a bead portion, and a bottom surface defining a depth of the recess. In a cross-section of the recess including a tire rotation axis, a sidewall surface located on an outer side in a tire radial direction and the bottom surface can be smoothly connected via an arc portion. The arc portion can have a radius of curvature equal to or larger than the depth of the recess.

### CROSS-REFERENCE TO RELATED APPLICATIONS

The present application claims priority to Japanese Application No. JP 2022-205897, filed Dec. 22, 2022, wherein the entire contents and disclosure are incorporated by reference herein.

### BACKGROUND

### Field

The present disclosure relates to a pneumatic tire.

### Background Art

Japanese Laid-Open Patent Publication No. 2021-151825 describes a pneumatic tire. The pneumatic tire includes a bead reinforcing layer placed in each bead portion thereof, and a plurality of recesses formed on the outer surface of the bead portion.

The above-described pneumatic tire is understood to be described as being able to generate turbulent flow around the bead portion during tire running, and this turbulent flow can cool the reinforcing layer placed inside the bead portion. Therefore, the effect of suppressing damage caused by heat generation around the reinforcing layer is expected.

However, it was found that when a plurality of recesses arranged in the tire circumferential direction are provided on each bead portion as in the above-described pneumatic tire, fine cracks are likely to occur inside the recesses and around the outer side in the tire radial direction of the recesses. Such fine cracks are formed around the surface of the tire, and thus are called “superficial cracking,” “SFC,” etc. Such fine cracks may not directly influence the running performance of the tire, but can have a problem of deteriorating the appearance of the tire.

### SUMMARY

According to an aspect, a pneumatic tire can include a pair of bead portions, wherein: a plurality of recesses are arranged in a tire circumferential direction on an outer surface of at least one of the pair of bead portions; the plurality of recesses each include a sidewall surface extending inward in a tire axial direction from the outer surface, and a bottom surface defining a depth of the recess; in at least one recess of the plurality of recesses, in a cross-section of the recess including a tire rotation axis, the sidewall surface located on an outer side in a tire radial direction and the bottom surface are smoothly connected via an arc portion; and the arc portion has a radius of curvature equal to or larger than the depth of the recess.

### BRIEF DESCRIPTION OF THE DRAWINGS

FIG. 1 is a tire meridian cross-sectional view of a pneumatic tire according to one or more embodiments of the present disclosure;

FIG. 2 is a perspective cross-sectional view of the pneumatic tire in FIG. 1;

FIG. 3 is a cross-sectional view of recesses;

FIG. 4 is an enlarged view of a bead portion in FIG. 1;

FIG. 5 is an enlarged view of the bead portion in FIG. 1;

FIG. 6 is a front view of the bead portion;

FIG. 7 is a front view of the bead portion; and

FIG. 8 is a cross-sectional view of a vulcanization mold for producing a pneumatic tire according to one or more embodiments of the present disclosure.

### DETAILED DESCRIPTION

Hereinafter, one or more embodiments of the present disclosure will be described with reference to the drawings.

The drawings may contain exaggerated expressions and expressions that differ from the dimensional ratio of the actual structure in order to help the understanding of embodiments of the present disclosure. In addition, when there are a plurality of embodiments, the same or common elements are denoted by the same reference characters throughout the description, and the redundant description thereof is omitted.

One or more embodiments of the present disclosure have been made in view of the above circumstances, and an object of the one or more embodiments of present disclosure, among one or more objects, can be to provide a pneumatic tire that can suppress occurrence of superficial cracking at a bead portion thereof while maintaining the durability of the bead portion.

As a result of employing configurations according to one or more embodiments of the present disclosure, such configurations can suppress occurrence of superficial cracking at the bead portion (hereinafter, such an effect is referred to as “SFC resistance performance”) while maintaining the durability of the bead portion.

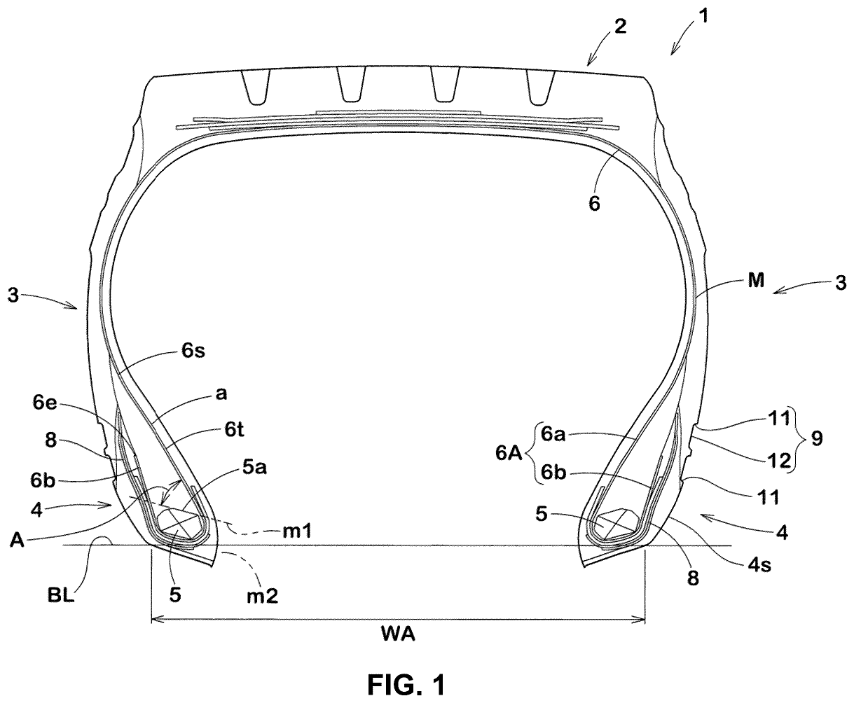

FIG. 1 is a tire meridian cross-sectional view, of a pneumatic tire (hereinafter, sometimes referred to simply as “tire”) 1 of one or more embodiments of the present disclosure, including a tire rotation axis. FIG. 1 shows a heavy duty tire 1 as a preferable mode. However, one or more embodiments of the present disclosure may be applied to, for example, a tire 1 for a motorcycle or a passenger car, i.e., a non-heavy duty tire.

In the present specification, unless otherwise specified, dimensions and the like of components of the tire 1 are values measured in a standardized state. The “standardized state” can be regarded as a state where the tire 1 is fitted on a standardized rim and inflated to a standardized internal pressure and no load is applied to the tire 1.

The “standardized rim” can be regarded as a rim that is defined, in a standard system including a standard on which the tire is based, by the standard for each tire, and is, for example, the “standard rim” in the JATMA standard, the “Design Rim” in the TRA standard, or the “Measuring Rim” in the ETRTO standard, as examples.

The “standardized internal pressure” can be regarded as an air pressure that is defined, in a standard system including a standard on which the tire is based, by the standard for each tire, and is the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard, as examples.

The tire 1 according to one or more embodiments of the present disclosure can include a pair of bead portions 4. A bead core 5 can be embedded in each bead portion 4. The tire 1 can also include, for example, a pair of sidewall portions 3 placed outward of the respective bead portions 4 in the tire radial direction, and a tread portion 2 connecting the respective sidewall portions 3.

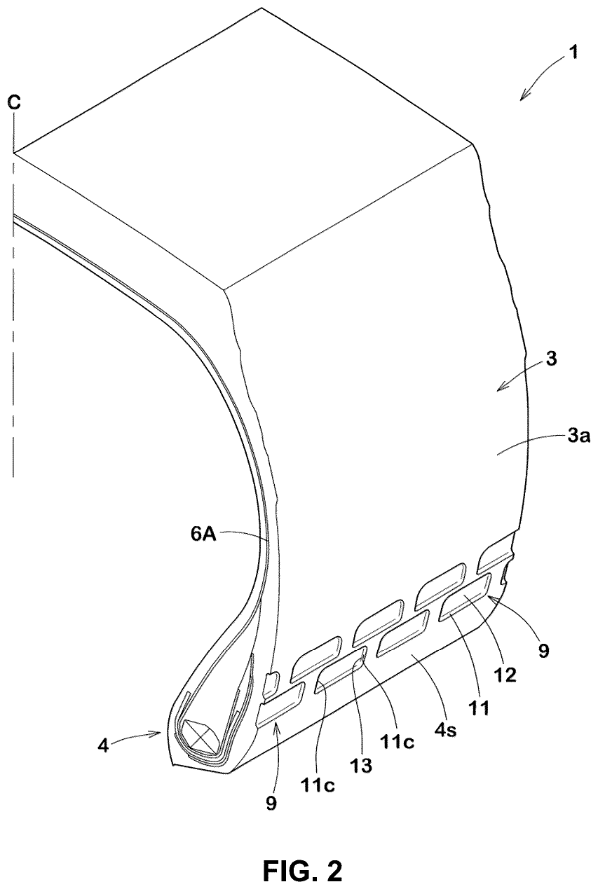

FIG. 2 is a perspective cross-sectional view of the tire 1 in FIG. 1. As shown in FIG. 1 and FIG. 2, a plurality of recesses 9 can be arranged in the tire circumferential direction on an outer surface 4s of at least one of the pair of bead portions 4. Such recesses 9 can generate turbulent flow at the outer surface 4s of the bead portion 4 during running of the tire 1 to cool the bead portion 4, which can improve the durability of the bead portion 4. In the present embodiment, the recesses 9 can be provided on each bead portion 4. In the present embodiment, the outer surface 4s can be a surface smoothly extending from an outer surface that defines a tire cross-sectional width (see, e.g., JATMA or the like).

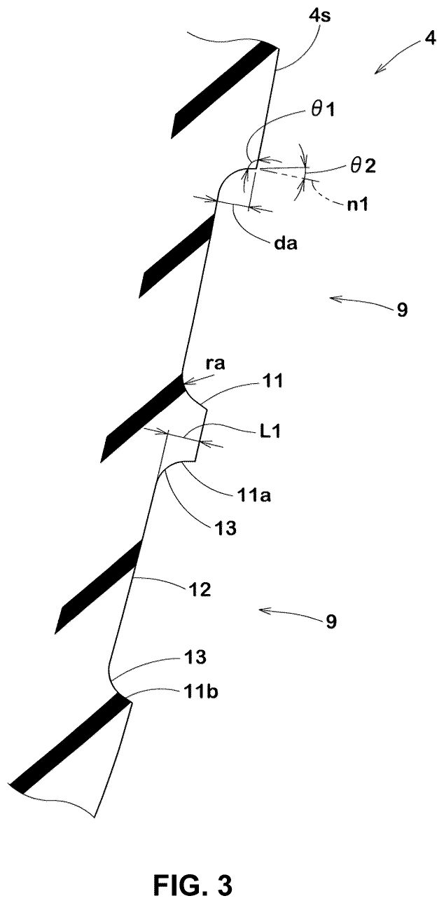

The plurality of recesses 9 can each include a sidewall surface 11 extending inward in the tire axial direction from the outer surface 4s, and a bottom surface 12 defining a depth da (shown in FIG. 3) of the recess 9.

FIG. 3 is a cross-sectional view of the recesses 9. FIG. 3 is also an enlarged view of the bead portion 4 in FIG. 1. As shown in FIG. 3, in at least one of the plurality of recesses 9, a sidewall surface 11a located on the outer side in the tire radial direction and the bottom surface 12 can be smoothly connected via an arc portion 13. The arc portion 13 can have a radius of curvature ra equal to or larger than the depth da of the recess 9. Accordingly, the stiffness of the bead portion 4 in the vicinity of the sidewall surface 11a on the outer side in the tire radial direction of the recess 9, where a large load acts during running, can be increased, for instance, so that concentration of strain generated in the vicinity is alleviated. Therefore, fine cracks that may be likely to occur in the vicinity of the recess 9 can be suppressed, for instance, so that SFC resistance performance can be improved.

In the present embodiment, in the recess 9, a sidewall surface 11b located on the inner side in the tire radial direction and the bottom surface 12 can be smoothly connected via an arc portion 13. In addition, in the recess 9, a pair of sidewall surfaces 11c (shown in FIG. 2) located on both sides in the tire circumferential direction and the bottom surface 12 can be smoothly connected via arc portions 13. The radius of curvature of the arc portion 13 connected to the sidewall surface 11b and the radius of curvature of the arc portion 13 connected to each sidewall surface 11c can be the same as the radius of curvature ra of the arc portion 13 connected to the sidewall surface 11a.

A length L1, in the depth direction of the recess 9, of each arc portion 13 can be not less than 50%, for instance, not less than 70 such as not less than 90% of the depth da of the recess 9. The arc portion 13 may extend, for example, to the outer surface 4s.

The radius of curvature ra of the arc portion 13 can be not less than 1.8 mm, as an example. Accordingly, generation of strain at the recess 9 can be effectively suppressed. According to one or more embodiments, the radius of curvature ra may be not greater than 5.0 mm.

As shown in FIG. 1, the tire 1 of the present embodiment can include a carcass 6 and a bead reinforcing layer 8.

The carcass 6 can include a carcass ply 6A that can include: a body portion 6a extending between the bead cores 5; and turned-up portions 6b each turned up from the inner side to the outer side in the tire axial direction around the bead core 5. In the present embodiment, the carcass 6 can be formed of one carcass ply 6A, but may be formed of a plurality of carcass plies. In the present embodiment, an outer end 6e in the tire radial direction of each turned-up portion 6b can be located inward of a tire maximum width position M in the tire radial direction. In the present specification, the tire maximum width position M can be regarded as a position at which the body portion 6a is located on the outermost side in the tire axial direction.

In the present embodiment, the body portion 6a can include an arc-shaped outward-facing arc portion 6s projecting outward in the tire axial direction, and an arc-shaped inward-facing arc portion 6t connected to the inner side in the tire radial direction of the outward-facing arc portion 6s and projecting inward in the tire axial direction. The outward-facing arc portion 6s and the inward-facing arc portion 6t can be connected at an inflection point a (point of intersection of tangent lines). The outward-facing arc portion 6s can include the tire maximum width position M. In the present embodiment, the inflection point a can be located outward of the outer end 6e in the tire radial direction of the turned-up portion 6b in the tire radial direction.

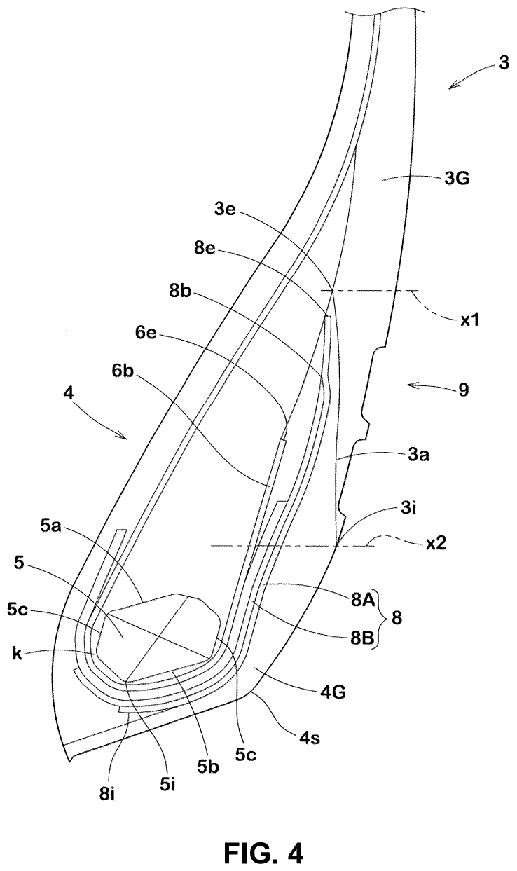

FIG. 4 is an enlarged view of the bead portion 4 in FIG. 1. As shown in FIG. 4, the bead reinforcing layer 8 can be located outward of the turned-up portion 6b in the tire axial direction and extends in the tire radial direction. An outer end 8e in the tire radial direction of the bead reinforcing layer 8 can be located, for example, outward of the outer end 6e of the turned-up portion 6b in the tire radial direction. An inner end 8i in the tire radial direction of the bead reinforcing layer 8 can be located, for example, inward of an inner end 5i in the tire radial direction of the bead core 5 in the tire radial direction. The bead reinforcing layer 8 can be formed as a reinforcing ply in which an array of reinforcing cords is covered with a topping rubber. The reinforcing cords can be, for example, nylon cords.

The bead reinforcing layer 8 of the present embodiment can include a first reinforcing ply 8A and a second reinforcing ply 8B. The first reinforcing ply 8A can be placed, for example, outward of the second reinforcing ply 8B in the tire axial direction. An outer end in the tire radial direction of the first reinforcing ply 8A can be, for example, the outer end 8e of the bead reinforcing layer 8. An outer end 8b in the tire radial direction of the second reinforcing ply 8B can be located, for example, outward of the outer end 6e of the turned-up portion 6b in the tire radial direction.

In the present embodiment, each bead core 5 can be formed in a hexagonal shape in the tire meridian cross-section. The bead core 5 can include an outer surface 5a located on the outer side in the tire radial direction, an inner surface 5b located on the inner side in the tire radial direction, and a pair of connection surfaces 5c connecting the outer surface 5a and the inner surface 5b. The outer surface 5a and the inner surface 5b can extend in a straight manner. Each connection surface 5c can include a bent portion k.

An angle A (shown in FIG. 1) between a virtual straight line m1 passing through the outer surface 5a of the bead core 5 and a tangent line m2 at the inflection point a of the body portion 6a can be not less than 25 degrees, for instance, not greater than 30 degrees. Since the angle A can be 25 to 30 degrees, falling-down of the body portion 6a during running can be suppressed, and deformation of the bead portion 4 during pressurizing the inside of the tire 1 can be reduced.

In the present embodiment, the tire 1 can include a sidewall rubber 3G located at the sidewall portion 3, and a clinch rubber 4G located at the bead portion 4. The sidewall rubber 3G and the clinch rubber 4G can be formed from rubber materials. In the present embodiment, the sidewall rubber 3G can form the recesses 9.

The sidewall rubber 3G can be adjacent to the clinch rubber 4G on the outer side in the tire radial direction and includes a boundary surface 3a which is in contact with the clinch rubber 4G. The boundary surface 3a can extend outward in the tire radial direction so as to be inclined toward the inner side in the tire axial direction. In addition, the recesses 9 can be formed between a tire axial line x1 passing through an outer end 3e in the tire radial direction of the boundary surface 3a and a tire axial line x2 passing through an inner end 3i in the tire radial direction of the boundary surface 3a. Furthermore, the outer end 8e of the bead reinforcing layer 8, the outer end 8b of the second reinforcing ply 8B, and the outer end 6e of the turned-up portion 6b can be located between both tire axial lines x1 and x2.

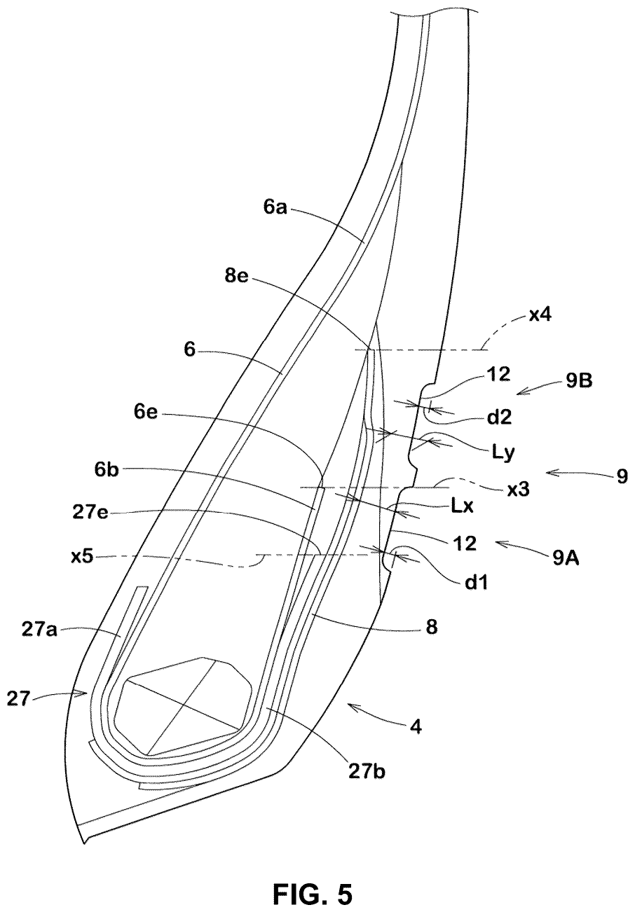

FIG. 5 is an enlarged view of the bead portion 4 in FIG. 1. As shown in FIG. 5, at least one recess 9 can be provided at a position intersecting a tire axial line x3 passing through the outer end 6e of the turned-up portion 6b. Accordingly, heat of the outer end 6e of the turned-up portion 6b can be effectively removed via the bottom surface 12 of the recess 9, for instance, so that damage to the outer end 6e can be suppressed. According to one or more embodiments, at least one recess 9 may be provided at a position intersecting a tire axial line x4 passing through the outer end 8e of the bead reinforcing layer 8. Accordingly, heat of the outer end 8e of the bead reinforcing layer 8 can be effectively removed, for instance, so that damage to the outer end 8e can be suppressed. In the present embodiment, the recesses 9 can be located inward of the tire axial line x4 in the tire radial direction. Accordingly, deformation based on strain due to each recess 9 can be inhibited from being applied to the outer end 8e of the bead reinforcing layer 8, for instance, so that the durability of the bead portion 4 is maintained high.

As shown in FIG. 3, at the intersection position between the sidewall surface 11 and the outer surface 4s, an angle θ1 between the sidewall surface 11 and the outer surface 4s can be an obtuse angle. An angle θ2 between the sidewall surface 11 and a normal line n1 that is normal to the outer surface 4s at the intersection position can be 10 to 30 degrees, as an example. Since the angle θ1 can be an obtuse angle and the angle θ2 may be not less than 10 degrees, the stiffness of the recess 9 can be maintained high to alleviate strain. Since the angle θ1 can be an obtuse angle and the angle θ2 may be not greater than 30 degrees, a cooling effect by turbulent flow can be exhibited. From such a viewpoint, according to one or more embodiments, the angle θ2 may be not less than 15 degrees not greater than 25 degrees. In the present embodiment, at the intersection position between each sidewall surface 11a, 11b, or 11c and the outer surface 4s, the angle θ1 can be an obtuse angle, and the angle θ2 can be 10 to 30 degrees.

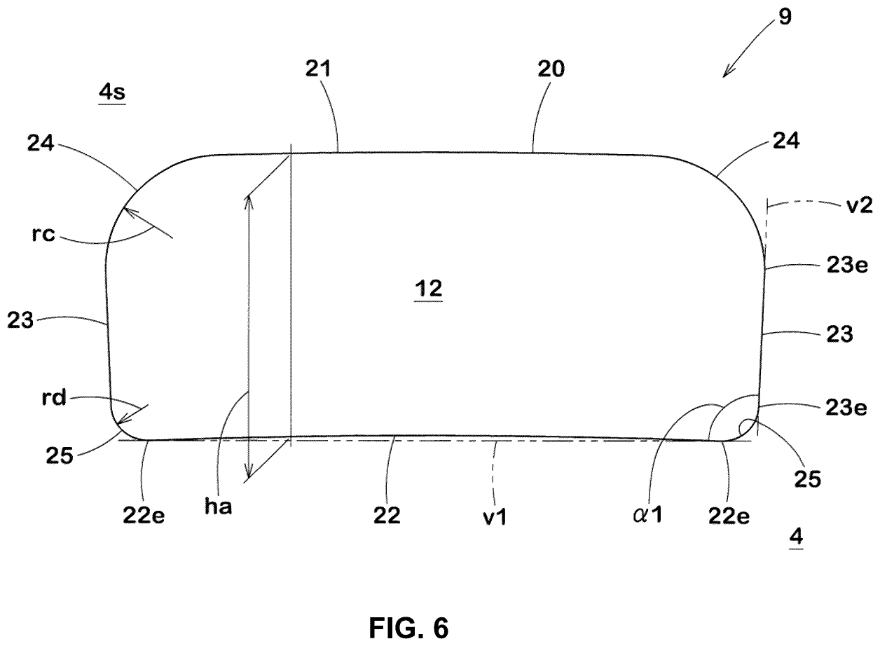

FIG. 6 is a front view of the bead portion 4, and is also an enlarged view of the recess 9. As shown in FIG. 6, the recess 9 can have an opening edge 20 in the outer surface 4s. The opening edge 20 can include a first edge 21 extending in the tire circumferential direction, a second edge 22 extending in the tire circumferential direction on the inner side in the tire radial direction of the first edge 21, and a pair of third edges 23 extending in the tire radial direction between the first edge 21 and the second edge 22. The recess 9 can also include a recess height ha which is the distance in the tire radial direction between the first edge 21 and the second edge 22.

The first edge 21 can be smoothly connected to each of the pair of third edges 23 via a first arc edge 24. Such a first arc edge 24 can further alleviate strain acting on the recess 9.

The recess height ha of at least one recess 9 can be 1 to 10 times a radius of curvature rc of the first arc edge 24, as an example. Since the recess height ha may not be less than 1 times the radius of curvature rc of the first arc edge 24, the stiffness in the vicinity of the first arc edge 24 of the recess 9 can be maintained high, for instance, so that the SFC resistance performance can be enhanced. Since the recess height ha may not be greater than 10 times the radius of curvature rc of the first arc edge 24, a decrease in the stiffness of the bead portion 4 due to the recess 9 can be suppressed. To effectively exhibit such an effect, the recess height ha can be not less than twice the radius of curvature rc of the first arc edge 24, for instance, not greater than 8 times the radius of curvature rc of the first arc edge 24.

In the present embodiment, the second edge 22 can be smoothly connected to each of the pair of third edges 23 via a second arc edge 25. Such a second arc edge 25 can also further alleviate strain acting on the recess 9. The radius of curvature rc of the first arc edge 24 can be formed so as to be equal to or larger than a radius of curvature rd of the second arc edge 25. Accordingly, the stiffness of an outer portion in the tire radial direction of the recess 9 where larger strain is likely to be generated can be maintained high. The radius of curvature rc of the first arc edge 24 can be greater than 1.0 times, for instance, not less than 1.5 times, such as not less than 2.0 times the radius of curvature rd of the second arc edge 25, not greater than 4.0 times or not greater than 3.5 times the radius of curvature rd of the second arc edge 25.

The first edge 21 and the second edge 22 can each extend, for example, in an arc shape that is convex outward in the tire radial direction. Accordingly, the stiffness of the bead portion 4 can be maintained high, and the appearance performance can be enhanced. In the present embodiment, the first edge 21 and the second edge 22 can each extend so as to overlap a circle centered at the tire rotation axis in a front view of the bead portion 4. The first edge 21 and the second edge 22 may extend, for example, in a straight manner. In the present embodiment, each third edge 23 can extend in a straight manner along the tire radial direction. The first edge 21 can form the sidewall surface 11a (shown in FIG. 3) located on the outer side in the tire radial direction. The second edge 22 can form the sidewall surface 11b located on the inner side in the tire axial direction. The third edges 23 can form the sidewall surfaces 11c (shown in FIG. 2) located on both sides in the tire circumferential direction.

An angle αl between the second edge 22 and the third edge 23 can be not less than 70 degrees, for instance, not less than 75 degrees, and can be not greater than 95 degrees, for instance, not greater than 90 degrees. Since the angle αl may not be less than 70 degrees, the length in the tire circumferential direction of the first edge 21 can be maintained. Therefore, a load during running can be supported by the first edge 21, for instance, so that occurrence of SFC can be suppressed. Since the angle αl may not be greater than 95 degrees, occurrence of cracking in the vicinity of the first arc edge 24 where a large load acts can be suppressed. In the present specification, the angle αl can be an angle between a virtual straight line v1 passing through both ends 22e of the second edge 22 and a virtual straight line v2 passing through both ends 23e of the third edge 23.

The depth da (shown in FIG. 3) of at least one recess 9 can be not less than 0.1 times, for instance, not less than 0.15 times the recess height ha of the recess 9, and can be not greater than 0.3 times, for instance, not greater than 0.25 times the recess height ha of the recess 9. Since the depth da of the recess 9 may not be less than 0.1 times the recess height ha, turbulent flow can be effectively generated. Since the depth da of the recess 9 may not be greater than 0.3 times the recess height ha, strain generated at the recess 9 can be alleviated. The depth da of the recess 9 can be not less than 1.0 mm and not greater than 4.0 mm.

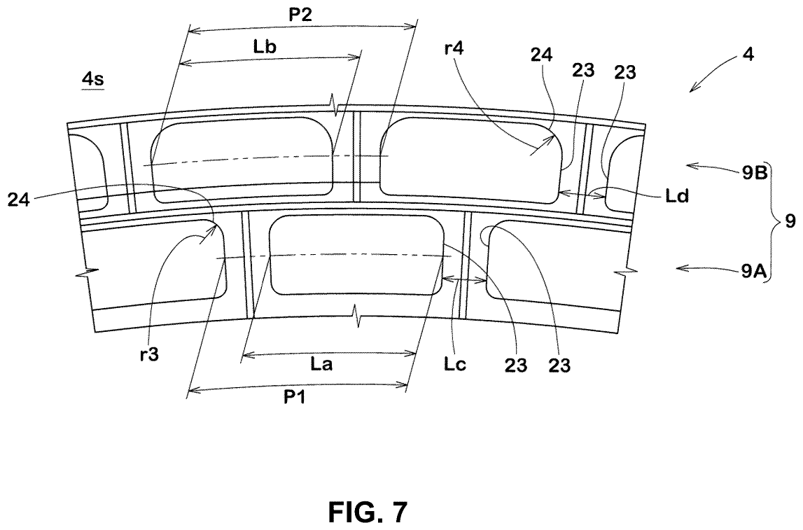

FIG. 7 is a front view of the bead portion 4. As shown in FIG. 7, the plurality of recesses 9 of the present embodiment can include a plurality of first recesses 9A arranged in the tire circumferential direction, and a plurality of second recesses 9B arranged in the tire circumferential direction on the outer side in the tire radial direction with respect to the first recesses 9A.

In the present embodiment, the plurality of first recesses 9A and the plurality of second recesses 9B can be arranged in a staggered pattern in the tire circumferential direction. This arrangement can suppress a decrease in the stiffness of the bead portion 4. In the present embodiment, the number of first recesses 9A arranged and the number of second recesses 9B arranged can be equal to each other.

A radius of curvature r4 of the first arc edge 24 of each second recess 9B can be formed so as to be larger than a radius of curvature r3 of the first arc edge 24 of each first recess 9A. Accordingly, the stiffness in the vicinity of the second recess 9B where a larger load acts can be maintained high, for instance, so that occurrence of SFC due to strain can be suppressed. The radius of curvature r4 of the first arc edge 24 of each second recess 9B can be not less than 1.2 times, for instance, not less than 1.5 times the radius of curvature r3 of the first arc edge 24 of each first recess 9A, and can be not greater than 3 times, for instance, not greater than 2.5 times the radius of curvature r3 of the first arc edge 24 of each first recess 9A.

A maximum length La in the tire circumferential direction of each first recess 9A can be not less than 0.60 times, for instance, not less than 0.65 times a pitch P1 in the tire circumferential direction of the first recess 9A, and can be not greater than 0.85 times, for instance, not greater than 0.80 times the pitch P1. A maximum length Lb in the tire circumferential direction of each second recess 9B can be not less than 0.50 times, for instance, not less than 0.55 times a pitch P2 in the tire circumferential direction of the second recess 9B, and can be not greater than 0.85 times, for instance, not greater than 0.80 times the pitch P2. According to one or more embodiments, the pitches P1 in the tire circumferential direction of the first recesses 9A can be the same in the tire circumferential direction. Similarly, the pitches P2 in the tire circumferential direction of the second recesses 9B can also be the same in the tire circumferential direction.

A length Lc in the tire circumferential direction between the third edge 23 of a first recess 9A and the third edge 23 of a first recess 9A adjacent thereto in the tire circumferential direction can continuously increase toward the outer side in the tire radial direction. Similarly, a length Ld in the tire circumferential direction between the third edge 23 of a second recess 9B and the third edge 23 of a second recess 9B adjacent thereto in the tire circumferential direction can continuously increase toward the outer side in the tire radial direction. Accordingly, the stiffness of an outer portion in the tire radial direction between each recess 9 where a large load is likely to act during running can be maintained, for instance, so that the SFC resistance performance can be enhanced.

As shown in FIG. 5, a shortest distance Lx between the bottom surfaces 12 of the plurality of first recesses 9A and the bead reinforcing layer 8 can be 2.5 to 3.5 times a depth d1 of the first recess 9A, as an example. In addition, a shortest distance Ly between the bottom surfaces 12 of the plurality of second recesses 9B and the bead reinforcing layer 8 can be 2.5 to 5.5 times a depth d2 of the second recess 9B, as an example. Accordingly, the cooling effect by the first recesses 9A and the second recesses 9B can be improved, and the stiffness can be maintained, for instance, so that the durability and the SFC resistance performance of the bead portion 4 can be improved in a well-balanced manner. According to one or more embodiments, the ratio (Lx/d1) of the shortest distance Lx to the depth d1 of the first recess 9A can be smaller than the ratio (Ly/d2) of the shortest distance Ly to the depth d2 of the second recess 9B.

Each bead portion 4 can be provided with a U-shaped reinforcing layer 27 placed between the bead reinforcing layer 8 and the carcass 6. The reinforcing layer 27 can be, for example, a cord ply in which a plurality of steel cords or organic fiber cords are covered with a topping rubber.

The reinforcing layer 27 can extend along the carcass 6 and can prevent contact between the bead reinforcing layer 8 and the carcass 6. The reinforcing layer 27 can include a first portion 27a extending along the body portion 6a, and a second portion 27b extending along the turned-up portion 6b. A tire axial line x5 passing through an outer end 27e in the tire radial direction of the second portion 27b can be located, for example, at a position intersecting the recess 9. According to one or more embodiments, the tire axial line x5 can be located at a position intersecting the first recess 9A. The outer end 27e of the second portion 27b can be located, for example, inward of the tire axial line x3 in the tire radial direction.

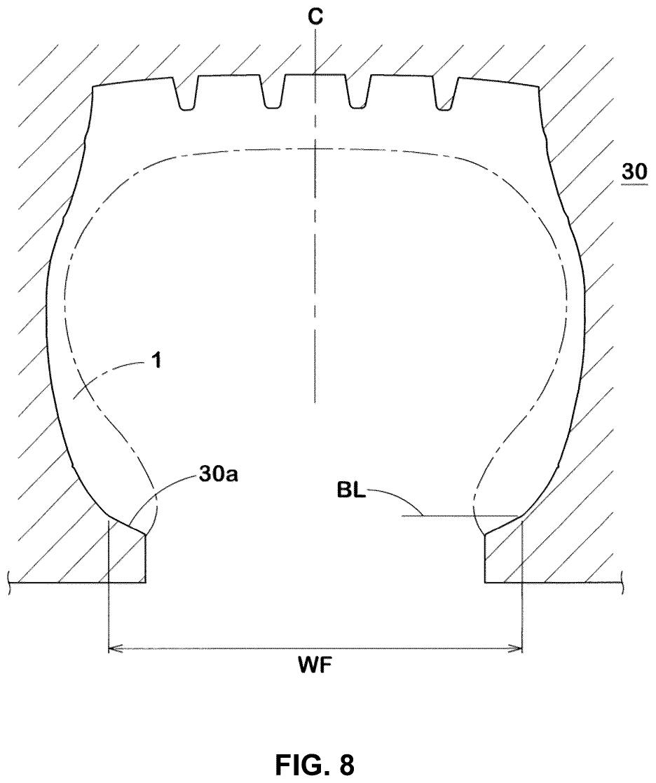

FIG. 8 is a cross-sectional view of a vulcanization mold 30 with a structure for producing the tire 1 according to one or more embodiments of the present disclosure. As shown in FIG. 8, in the vulcanization mold 30, a ratio WA/WF of a rim width (see JATMA or the like) WA (shown in FIG. 1) of a standardized rim) to a mold clip width WF can be 1.02 to 1.17, as an example. In the present specification, the mold clip width WF can be regarded as the length in the tire axial direction of an inner cavity surface 30a of the vulcanization mold 30 at a position that coincides with a bead base line BL of the tire 1. When the ratio WA/WF is less than 1.02, it may be difficult to pressurize the inside of the tire 1. If the ratio WA/WF exceeds 1.17, strain generated during running may increase, which can result in deterioration of the SFC resistance performance. The bead base line BL can be regarded as a line that defines the rim diameter (see JATMA or the like) of a rim.

Although the particularly embodiments of the present disclosure have been described in detail above, embodiments of the present disclosure are not limited to the above-described embodiment, and various modifications can be made.

### EXAMPLES

Heavy duty pneumatic tires with a size of 315/80R22.5 having the basic structure in FIG. 1 were produced as sample tires on the basis of specifications in Table 1. Each sample tire was tested for SFC resistance performance. The test method is as follows. Each sample tire had the same specifications except for the presence/absence of a bead reinforcing layer and the shape of each recess.

### <SFC Resistance Performance>

While causing each sample tire to run on a drum under the following conditions, ozone was sprayed to the recesses of the bead portion by an ozone generator, and the state of occurrence of SFC was checked. The test results were evaluated on a 3-point scale through sensory evaluation by a tester.
Rim: 22.5×9.00
Internal pressure: 830 kPa
Load: 38.56 kN
Speed: 40 km/h
Ozone concentration: 50±5 pphm
Running time: 400 hours
Angle θ1: obtuse angle
da: 1.8 mm

TABLE 1

| | | Comparative | Comparative | Comparative |
|---|---|---|---|---|
| | Example | Example 1 | Example 2 | Example 3 |
| Presence/absence | Presence | Presence | Presence | Absence |
| of bead reinforc- | | | | |
| ing layer | | | | |
| ra (mm) | 1.9 | 1.4 | 0.75 | 0.75 |
| θ2 (degrees) | 20 | 20 | 10 | 10 |
| SFC resistance | 3 | 2 | 2 | 1 |
| performance | | | | |
| [out of 3 points] | | | | |

As shown in Table 1, the tire of the Example has better SFC resistance performance than the tire of each Comparative Example. It is also found that in the tire of the Example, the durability of the bead portion is maintained high.

### [Additional Note]

One or more embodiments of the present disclosure can include the following aspects.

### [Disclosure 1]

A pneumatic tire including a pair of bead portions, wherein
a plurality of recesses are arranged in a tire circumferential direction on an outer surface of at least one of the pair of bead portions,
the plurality of recesses each include a sidewall surface extending inward in a tire axial direction from the outer surface, and a bottom surface defining a depth of the recess,
in at least one recess of the plurality of recesses, in a cross-section of the recess including a tire rotation axis,
the sidewall surface located on an outer side in a tire radial direction and the bottom surface are smoothly connected via an arc portion, and
the arc portion has a radius of curvature equal to or larger than the depth of the recess.

### [Disclosure 2]

The pneumatic tire according to Disclosure 1, wherein the radius of curvature of the arc portion is not less than 1.8 mm.

### [Disclosure 3]

The pneumatic tire according to Disclosure 1 or Disclosure 2, wherein, at an intersection position between the sidewall surface and the outer surface, an angle between the sidewall surface and the outer surface is an obtuse angle, and an angle between the sidewall surface and a normal line that is normal to the outer surface at the intersection position is 10 to 30 degrees.

### [Disclosure 4]

The pneumatic tire according to any one of Disclosure 1 to Disclosure 3, wherein
the plurality of recesses each have an opening edge in the outer surface,
the opening edge includes a first edge extending in the tire circumferential direction, a second edge extending in the tire circumferential direction on an inner side in the tire radial direction of the first edge, a pair of third edges extending in the tire radial direction between the first edge and the second edge, and a recess height that is a distance in the tire radial direction between the first edge and the second edge,
the first edge is smoothly connected to each of the pair of third edges via a first arc edge, and
the recess height of the at least one recess is 1 to 10 times a radius of curvature of the first arc edge.

### [Disclosure 5]

The pneumatic tire according to Disclosure 4, wherein
the second edge is smoothly connected to each of the pair of third edges via a second arc edge, and
the radius of curvature of the first arc edge is equal to or larger than a radius of curvature of the second arc edge.

### [Disclosure 6]

The pneumatic tire according to Disclosure 4 or Disclosure 5, wherein the depth of the at least one recess is 0.1 to 0.3 times the recess height.

### [Disclosure 7]

The pneumatic tire according to any one of Disclosure 4 to Disclosure 6, wherein
the plurality of recesses include a plurality of first recesses arranged in the tire circumferential direction, and a plurality of second recesses arranged in the tire circumferential direction on the outer side in the tire radial direction with respect to the first recesses, and
the radius of curvature of the first arc edge of each of the second recesses is larger than the radius of curvature of the first arc edge of each of the first recesses.

### [Disclosure 8]

The pneumatic tire according to any one of Disclosure 1 to Disclosure 7, further including a carcass, wherein
the carcass includes a carcass ply including: a body portion extending between bead cores embedded in the pair of bead portions, respectively; and turned-up portions each turned up from an inner side to an outer side in the tire axial direction around the bead core, and
the at least one recess is provided at a position intersecting a tire axial line passing through an outer end in the tire radial direction of the turned-up portion.

### [Disclosure 9]

The pneumatic tire according to Disclosure 8, wherein
a bead reinforcing layer is further placed on the outer side in the tire axial direction of the turned-up portion so as to extend in the tire radial direction, and
the at least one recess is provided at the position intersecting the tire axial line passing through the outer end in the tire radial direction of the bead reinforcing layer.

### [Disclosure 10]

The pneumatic tire according to Disclosure 9, wherein
the plurality of recesses include a plurality of first recesses arranged in the tire circumferential direction, and a plurality of second recesses arranged in the tire circumferential direction on the outer side in the tire radial direction with respect to the first recesses, and
a shortest distance between the bottom surfaces of the plurality of second recesses and the bead reinforcing layer is 2.5 to 5.5 times of the depth of the second recess.

What is claimed is:

1. A pneumatic tire comprising a pair of bead portions, wherein
a plurality of recesses arranged in a tire circumferential direction on an outer surface of at least one of the pair of bead portions,
the plurality of recesses each including a sidewall surface extending inward in a tire axial direction from the outer surface, and a bottom surface defining a depth of the recess,
in at least one recess of the plurality of recesses, in a cross-section of the recess including a tire rotation axis,
the sidewall surface located on an outer side in a tire radial direction and the bottom surface are smoothly connected via an arc portion, and
the arc portion has a radius of curvature equal to or larger than the depth of the recess.

2. The pneumatic tire according to claim 1, wherein the radius of curvature of the arc portion is not less than 1.8 mm.

3. The pneumatic tire according to claim 1, wherein, at an intersection position between the sidewall surface and the outer surface, an angle between the sidewall surface and the outer surface is an obtuse angle, and an angle between the sidewall surface and a normal line that is normal to the outer surface at the intersection position is 10 to 30 degrees.

4. The pneumatic tire according to claim 1, wherein
the plurality of recesses each have an opening edge in the outer surface,
the opening edge includes a first edge extending in the tire circumferential direction, a second edge extending in the tire circumferential direction on an inner side in the tire radial direction of the first edge, a pair of third edges extending in the tire radial direction between the first edge and the second edge, and a recess height that is a distance in the tire radial direction between the first edge and the second edge,
the first edge is smoothly connected to each of the pair of third edges via a first arc edge, and
the recess height of the at least one recess is 1 to 10 times a radius of curvature of the first arc edge.

5. The pneumatic tire according to claim 4, wherein
the second edge is smoothly connected to each of the pair of third edges via a second arc edge, and
the radius of curvature of the first arc edge is equal to or larger than a radius of curvature of the second arc edge.

6. The pneumatic tire according to claim 4, wherein the depth of the at least one recess is 0.1 to 0.3 times the recess height.

7. The pneumatic tire according to claim 5, wherein
the plurality of recesses include a plurality of first recesses arranged in the tire circumferential direction, and a plurality of second recesses arranged in the tire circumferential direction on the outer side in the tire radial direction with respect to the first recesses, and
the radius of curvature of the first arc edge of each of the second recesses is larger than the radius of curvature of the first arc edge of each of the first recesses.

8. The pneumatic tire according to claim 1, further comprising a carcass, wherein
the carcass includes a carcass ply including:
a body portion extending between bead cores embedded in the pair of bead portions, respectively; and
turned-up portions each turned up from an inner side to an outer side in the tire axial direction around the bead core, and
the at least one recess is provided at a position intersecting a tire axial line passing through an outer end in the tire radial direction of the turned-up portion.

9. The pneumatic tire according to claim 8, wherein
a bead reinforcing layer is further placed on the outer side in the tire axial direction of the turned-up portion so as to extend in the tire radial direction, and
the at least one recess is provided at the position intersecting the tire axial line passing through the outer end in the tire radial direction of the bead reinforcing layer.

10. The pneumatic tire according to claim 9, wherein
the plurality of recesses include a plurality of first recesses arranged in the tire circumferential direction, and a plurality of second recesses arranged in the tire circumferential direction on the outer side in the tire radial direction with respect to the first recesses, and
a shortest distance between the bottom surfaces of the plurality of second recesses and the bead reinforcing layer is 2.5 to 5.5 times of the depth of the second recess.

11. A pneumatic tire comprising a pair of bead portions, wherein
a plurality of recesses arranged in a tire circumferential direction on an outer surface of at least one of the pair of bead portions,
the plurality of recesses each including a sidewall surface extending inward in a tire axial direction from the outer surface, and a bottom surface defining a depth of the recess,
in at least one recess of the plurality of recesses, in a cross-section of the recess including a tire rotation axis,
the sidewall surface located on an outer side in a tire radial direction and the bottom surface are smoothly connected via an arc portion,
the arc portion has a radius of curvature equal to or larger than the depth of the recess,
each of the recesses is elongate in the tire circumferential direction,
for each of the plurality of recesses, an intersection position between the sidewall surface and the outer surface is an obtuse angle, and an angle between the sidewall surface and a normal line that is normal to the outer surface at the intersection position is in a range of 10 to 30 degrees,
the plurality of recesses each have an opening edge in the outer surface, the opening edge includes a first edge extending in the tire circumferential direction, a second edge extending in the tire circumferential direction on an inner side in the tire radial direction of the first edge, a pair of third edges extending in the tire radial direction between the first edge and the second edge, and a recess height that is a distance in the tire radial direction between the first edge and the second edge,
the first edge is smoothly connected to each of the pair of third edges via a first arc edge, and
for each of the plurality of recesses, a recess height is 1 to 10 times a radius of curvature of the first arc edge.

12. The pneumatic tire according to claim 11, wherein the radius of curvature of the arc portion is not less than 1.8 mm.

13. The pneumatic tire according to claim 11, wherein
the second edge is smoothly connected to each of the pair of third edges via a second arc edge, and
the radius of curvature of the first arc edge is equal to or larger than a radius of curvature of the second arc edge.

14. The pneumatic tire according to claim 11, wherein the depth of the at least one recess is 0.1 to 0.3 times the recess height.

15. The pneumatic tire according to claim 11, wherein
the plurality of recesses include a plurality of first recesses arranged in the tire circumferential direction, and a plurality of second recesses arranged in the tire circumferential direction on the outer side in the tire radial direction with respect to the first recesses, and
the radius of curvature of the first arc edge of each of the second recesses is larger than the radius of curvature of the first arc edge of each of the first recesses.

16. The pneumatic tire according to claim 11, further comprising a carcass, wherein
the carcass includes a carcass ply including:
a body portion extending between bead cores embedded in the pair of bead portions, respectively; and
turned-up portions each turned up from an inner side to an outer side in the tire axial direction around the bead core, and
the at least one recess is provided at a position intersecting a tire axial line passing through an outer end in the tire radial direction of the turned-up portion.

17. The pneumatic tire according to claim 16, wherein
a bead reinforcing layer is further placed on the outer side in the tire axial direction of the turned-up portion so as to extend in the tire radial direction, and
the at least one recess is provided at the position intersecting the tire axial line passing through the outer end in the tire radial direction of the bead reinforcing layer.

18. The pneumatic tire according to claim 17, wherein
the plurality of recesses include a plurality of first recesses arranged in the tire circumferential direction, and a plurality of second recesses arranged in the tire circumferential direction on the outer side in the tire radial direction with respect to the first recesses, and
a shortest distance between the bottom surfaces of the plurality of second recesses and the bead reinforcing layer is 2.5 to 5.5 times of the depth of the second recess.
